(19) United States
(12) Patent Application Publication
(10) Pub. No.: US 2007/0202293 A1
(43) Pub. Date: Aug. 30, 2007

(54) Doormat with interchangeable inserts

(75) Inventor: Deborah Powell, Rancho Santa Margarita, CA (US)

Correspondence Address: EPSTEIN DRANGEL BAZERMAN & JAMES, LLP, 60 EAST 42ND STREET, SUITE 820, NEW YORK, NY, 10165, US

(73) Assignee: Glenoit LLC

(21) Appl. No.: 11/363,887

(22) Filed: Feb. 27, 2006

(51) Int. Cl. B44C 1/26

(52) U.S. Cl. 428/67; 428/137

(57) ABSTRACT

The present invention relates to a doormat having a base and one or more interchangeable inserts. The base has an insert-receiving recess. The recess is defined by a generally planar member having a surface upon which an insert may be supported. It is also defined by a side member that extends upwardly from the plane of the support member surface by a distance equal to the thickness of the insert and is adapted to be situated proximate the edge of an insert, when an insert is situated on the insert support member surface. The base also includes a frame-like section extending outwardly from the side member and substantially surrounding the recess. The inserts are alternately receivable in the recess and may have subject matter related surface ornamentation.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to doormats and more particularly to a doormat with interchangeable inserts that extend the useful life of the product and provide an aesthetically pleasing appearance that can be changed as desired.

2. Description of Prior Art Including Information Disclosed Under 37 CFR 1.97 and 1.98

Doormats made of various materials and of a variety of dimensions have been known for many years. Many are formed of coir, which is a stiff coarse fiber obtained from the outer husk of a coconut. Others are made of rubber or rubber substitutes.

It is also know to form doormats with aesthetically pleasing surface ornamentation and configurations. This can be done by using different color materials, by imprinting various surface designs or creating borders of different shapes.

However, although it is desirable to have same, to the best of my knowledge, there has never been a doormat with interchangeable inserts, which would substantially extend the useful life of the doormat. Further, there has never been a doormat with interchangeable inserts imprinted with subject matter related ornamentation, such as, seasonal images, such that the appearance of the doormat could be changed as desired, for example, to coordinate with the seasons of the year.

It is therefore a prime object of the present invention to provide a doormat with interchangeable inserts.

It is another object to provide a doormat made of rubber with interchangeable inserts made of coir.

It is another object of the present invention to provide a doormat with interchangeable inserts imprinted with subject matter related images.

### BRIEF SUMMARY OF THE INVENTION

In accordance with a first aspect of the present invention, a doormat is provided including a base and a removable insert. The base includes an insert-receiving recess defined by a generally planar member having a surface adapted to support the insert. A side member extends upwardly from the plane of the insert support member surface a given distance and is situated proximate the edge of the insert, when the insert is situated on the insert support member surface. The base also includes a frame-like section extending outwardly from the side member and substantially surrounding the recess.

In accordance with a second aspect of the present invention, a doormat is provided including a base and first and second interchangeable inserts. The base includes an insert-receiving recess. The recess is defined by a generally planar member having a surface upon which an insert may be supported. A side member extends upwardly from the plane of the insert support member surface a given distance. The side member is adapted to be situated proximate the edge of an insert, when the insert is situated on the insert support member surface. The base also includes a frame-like section extending outwardly from the side member and substantially surrounding the recess. The first and second inserts are alternately receivable in the recess.

Preferably, the base is composed of rubber and the insert is composed of coir.

The insert support member surface is preferably substantially the same shape and size as the inserts. Preferably, the insert supporting surface is substantially devoid of openings.

Each of the inserts has a thickness approximately equal to the given distance. Thus, the top surface of the insert will be substantially coplanar with the top edge of the side member, when the insert is situated in the recess.

The frame-like section includes an outer edge member spaced from the side member. The frame-like section has an intermediate portion situated between the side member and the outer edge member. The intermediate portion has a plurality of openings. The openings are formed by a plurality of spaced, arcuate members.

The outer edge member includes a channel formed in the surface thereof.

The first insert has a first design printed in the surface thereof. The second insert has a second design printed on the surface thereof. Preferably, the first and second designs are subject matter related.

### BRIEF DESCRIPTION OF THE SEVERAL VIEWS OF DRAWINGS

To these and to such other objects that may hereinafter appears, the present invention relates to a doormat with interchangeable inserts as described in detail in the following specification and recited in the annexed claims, taken together with the accompanying drawings, in which like numerals refer to like parts and in which:

FIG. 1 is a plan view of the top of the doormat of the present invention with one of the inserts in place;

FIG. 2 is a fragmentary cross-sectional view taken along line 2-2 of FIG. 1;

FIG. 3 is a fragmentary cross-sectional view taken along line 3-3 of FIG. 1; and

FIG. 4 is a plan view of the top of the doormat of the present invention without the inserts in place and four interchangeable inserts with subject matter related surface ornamentation.

### DETAILED DESCRIPTION OF THE INVENTION

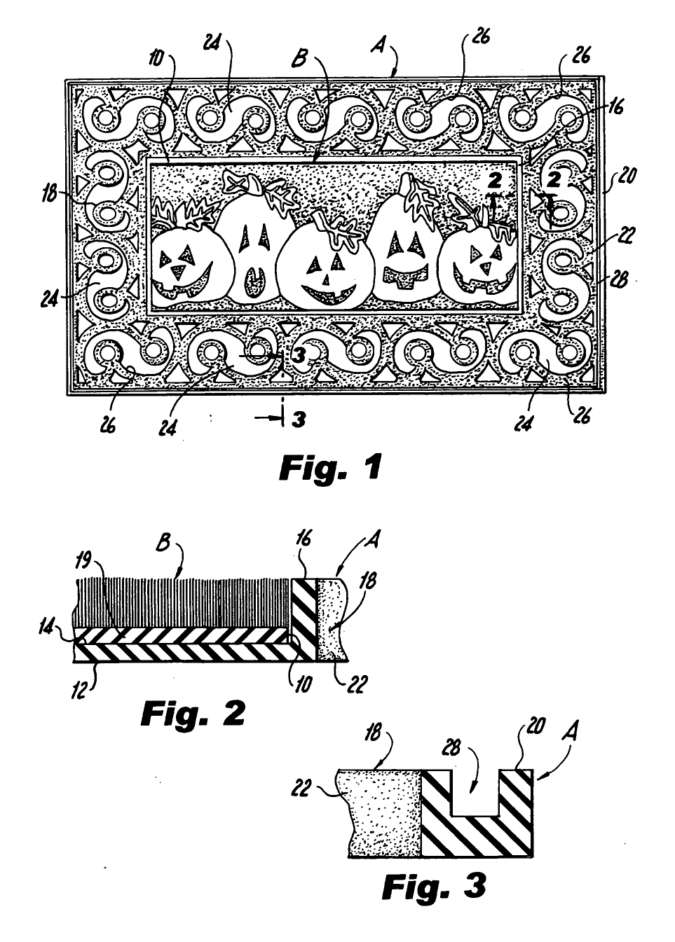

As seen in FIG. 1, the doormat of the present invention includes a base, generally designated A, and one or more removable inserts, generally designated B. Base A has a centrally located recess 10 adapted to receive an insert B therein. Recess 10 defined by a generally planar member 12 having a top surface 14 adapted to support an insert and a side member 16 extending upwardly from the plane of the support member surface 14 a given distance and situated proximate the edge of insert B, when the insert is situated on insert support member surface 14. Base A also includes a frame-like section 18 extending outwardly from side member 16 and substantially surrounding recess 10.

Preferably, the base A of the doormat is composed of rubber or a rubber-like material and the inserts B are composed of coir with a rubberized backing 19.

Preferably, support member surface 14 is substantially the same shape and size as the inserts B and is substantially devoid of openings.

Preferably, each of the inserts B has a thickness approximately equal to the height of the side member 16, as measured from the plane of surface 14 to the upper edge of the side member, such that the top surface of an insert situated in recess 10 is substantially coplanar with the top edge of the side member, as illustrated in FIG. 2.

Frame-like section 18 has an outer edge member 20 that is spaced from side member 16. An intermediate portion 22 is situated between the side member and the outer edge member. The intermediate portion 22 has a plurality of openings 24 formed between a plurality of spaced arcuate members 26 in order to facilitate the removal of ice and snow from the bottom of shoes or boots and also to provide a decorative affect.

Preferably, a channel 28 is formed in the top surface of outer edge member 20, as is illustrated in FIG. 3. Channel 28 serves to collect melted ice and snow as it is removed from the shoes or boots.

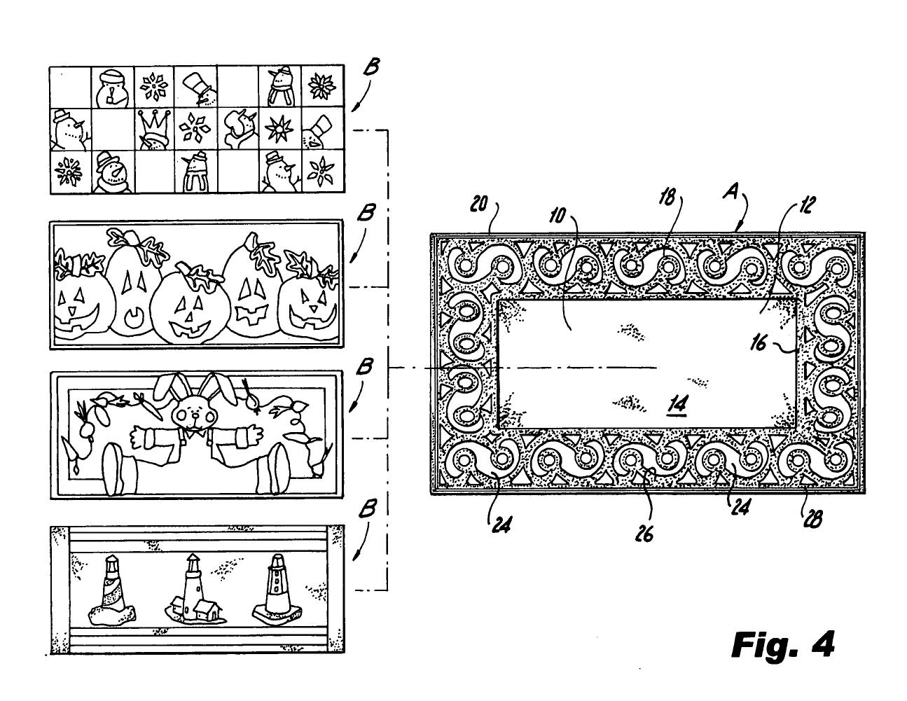

As illustrated in FIG. 4, several inserts B are provided to be interchangeably received in recess 10. Each insert has a design printed in the surface thereof. Preferable, the designs are subject matter related. For example, the inserts shown in FIG. 4 have seasonal designs. The top insert has a winter design, including snowmen. The next has a fall design with pumpkins. The third has a spring design with an Easter bunny. The bottom has a summer design with light houses. The inserts can be removed from the base and inserted into the recess as desired.

It will now be appreciated that the present invention relates to a doormat having a base and one or more interchangeable inserts. The base has an insert-receiving recess. The recess is defined by a generally planar member having a surface upon which an insert may be supported. It is also defined by a side member that extends upwardly from the plane of the member surface a distance equal to the thickness of the insert. The side member is situated proximate the edge of an insert, when the insert is situated on the insert support member surface. The base also includes a frame-like section extending outwardly from the side member and substantially surrounding the recess. The inserts are alternately receivable in the recess and may have subject matter related surface ornamentation.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

I claim:

1. A doormat comprising a base and a removable insert, said base comprising an insert-receiving recess, said recess being defined by a generally planar member having a surface adapted to support the insert and a side member extending upwardly from the plane of said support member surface a given distance and situated proximate the edge of said insert, when said insert is situated on said insert support member surface, said base further comprising a frame-like section extending outwardly from said side member and substantially surrounding said recess.

2. The doormat of claim 1 wherein said base is composed of rubber.

3. The doormat of claim 1 wherein said insert is composed of coir.

4. The doormat of claim 1 wherein said insert support member surface is substantially the same shape and size as said insert.

5. The doormat of claim 1 wherein said insert support member surface is substantial devoid of openings.

6. The doormat of claim 1 wherein said insert has a thickness approximately equal to said given distance.

7. The doormat of claim 1 wherein said frame-like section comprises an outer edge member and wherein said outer edge member is spaced from said side member.

8. The doormat of claim 7 wherein said frame-like section further comprises an intermediate portion situated between said side member and said outer edge member.

9. The doormat of claim 8 wherein said intermediate portion comprises a plurality of openings.

10. The doormat of claim 8 wherein said intermediate portion comprises a plurality of spaced arcuate members.

11. The doormat of claim 7 wherein said outer edge member comprises a channel.

12. The doormat of claim 1 further comprising a second insert adapted to be received in said recess.

13. The doormat of claim 12 wherein said second insert is receivable in said recess when said insert is not present therein.

14. The doormat of claim 12 wherein said insert has a first design printed in the surface thereof.

15. The doormat of claim 14 wherein said second insert has a second design printed on the surface thereof and wherein said first and second designs are subject matter related.

16. A doormat comprising a base and first and second interchangeable inserts, said base comprising an insert-receiving recess, said recess being defined by a generally planar member having a surface upon which an insert may be supported and a side member extending upwardly from the plane of said member surface a given distance and adapted to be situated proximate the edge of an insert, when an insert is situated on said insert support member surface, said base further comprising a frame-like section extending outwardly from said side member and substantially surrounding said recess, said first and second inserts being alternately receivable in said recess.

17. The doormat of claim 16 wherein said base is composed of rubber.

18. The doormat of claim 16 wherein said insert is composed of coir.

19. The doormat of claim 16 wherein said insert support member surface is substantially the same shape and size as said inserts.

20. The doormat of claim 16 wherein said insert support member surface has no openings.

21. The doormat of claim 16 wherein each of said inserts has a thickness approximately equal to said given distance.

22. The doormat of claim 16 wherein said frame-like section comprises an outer edge member spaced from said side member.

23. The doormat of claim 22 wherein said frame-like section further comprises an intermediate portion situated between said side member and said outer edge member.

24. The doormat of claim 23 wherein said intermediate portion comprises a plurality of openings.

25. The doormat of claim 23 wherein said intermediate portion comprises a plurality of spaced, arcuate members.

26. The doormat of claim 22 wherein said outer edge member comprises first and second spaced elements defining a recess therebetween.

27. The doormat of claim 16 wherein said first insert has a first design printed in the surface thereof.

28. The doormat of claim 27 wherein said second insert has a second design printed on the surface thereof and wherein said first and second designs are subject matter related.
